(19) United States
(12) Patent Application Publication
(10) Pub. No.: US 2011/0075966 A1
(43) Pub. Date: Mar. 31, 2011

(54) Optical Interconnect

(76) Inventors: David A. Fattal, Mountain View, CA (US); Duncan Stewart, Menlo Park, CA (US); Wei Wu, Mountain View, CA (US)

(21) Appl. No.: 12/994,118

(22) PCT Filed: May 23, 2008
(86) PCT No.: PCT/US2008/064761

§ 371 Date: Nov. 22, 2010

(51) Int. Cl. G02B 6/12

(52) U.S. Cl. 385/14

(57) ABSTRACT

An optical interconnect has first and second substantially perpendicular optical waveguides and an optical grating disposed between and evanescently coupled to the waveguides. The optical grating includes a plurality perforated rows that are oriented at an angle of approximately 45 degrees with respect to the first and second optical waveguides.

### BACKGROUND

Light beams or optical signals are frequently used to transmit digital data, for example, in fiber optic systems for long-distance telephony and internet communication. Additionally, much research has been done regarding the use of optical signals to transmit data between electronic components on circuit boards.

Consequently, optical technology plays a significant role in modern telecommunications and data communication. Examples of optical components used in such systems include optical or light sources such as light emitting diodes and lasers, waveguides, fiber optics, lenses and other optics, photo-detectors and other optical sensors, optically-sensitive semiconductors, optical modulators, and others.

Systems making use of optical components often rely upon the precise manipulation of optical energy, such as a beam of light, to accomplish a desired task. This is especially true in systems utilizing light for high-speed, low-energy communication between two nodes.

Often waveguides are used to route modulated optical beams along a predetermined path. An optical waveguides is typically able to transmit optical beams received at a first end of the waveguide to a second end with minimal loss using the principles of total internal reflection. Additionally, some types of optical waveguides (e.g. optical fibers) are generally flexible, and may be used to route optical beams around corners or along paths that are curved or otherwise non-linear.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIGS. 1A and 1B are front and side views of an illustrative optical interconnect according to one embodiment of the principles described herein.

FIG. 2 is a diagram of illustrative momentum vectors corresponding to an optical interconnect according to one embodiment of the principles described herein.

FIG. 3 is a diagram of an illustrative grating pattern in an optical interconnect according to one embodiment of the principles described herein.

FIG. 4 is a side view illustration of illustrative evanescent fields in an optical interconnect, according to one embodiment of the principles described herein.

FIGS. 5A-5B are front views of an illustrative optical interconnect in different configurations, according to one embodiment of the principles described herein.

FIG. 6 is a front view of an illustrative optical interconnect according to one embodiment of the principles described herein.

FIG. 7 is a front view of an illustrative optical interconnect according to one embodiment of the principles described herein.

FIG. 8 is a front view of an illustrative optical interconnect according to one embodiment of the principles described herein.

FIG. 9 is a front view of an illustrative optical interconnect according to one embodiment of the principles described herein.

FIG. 10 is a block diagram of an illustrative optical system according to one embodiment of the principles described herein.

FIG. 11 is a flowchart of an illustrative method of transmitting an optical signal according to one embodiment of the principles described herein.

Throughout the drawings, identical reference numbers designate similar, but not necessarily identical, elements.

### DETAILED DESCRIPTION

As noted above, optical beams may be used in a variety of applications including the transmission of digital data. In some such systems, optical beams are directed or redirected in an optical path where they may be received or detected by a designated component. In such systems, optical so waveguides are often used to route modulated optical beams along a predetermined path.

Optical waveguides are typically able to transmit optical beams received at a first end of the guide to a second end with minimal loss using the principles of total internal reflection. Optical fibers are a type of optical waveguide that are generally flexible and may be used to route optical beams around corners or along paths that are curved or otherwise non-linear.

In some cases, it may be desirable to transfer a portion of an optical beam propagating through a first optical waveguide into a second optical waveguide such that data and/or power from the optical beam may be transmitted through both the first and second waveguides. It may also be desirable to couple the optical beam to the second optical waveguide with minimal losses from optical impedance, reflection, and free space radiation. Furthermore, it may be desirable to provide an optical interconnect that is tolerant of alignment shifts between transmitting and receiving waveguides.

To accomplish these and other goals, the present specification discloses illustrative systems and methods in which a periodic grating is disposed between a first optical fiber and a second optical fiber that are substantially perpendicular to each other. The periodic grating may be evanescently coupled to the first and second waveguides and include a plurality of perforated rows oriented at an angle of approximately 45 degrees with respect to both waveguides. The optical grating may be configured to provide an angular momentum required to couple optical energy propagating through the first waveguide into the second waveguide without causing back reflection or free space radiation optical losses.

As used in the present specification and in the appended claims, the term “optical energy” refers to radiated energy having a wavelength generally between 10 nanometers and 500 microns. Optical energy as thus defined includes, but is not limited to, ultraviolet, visible, and infrared light. A beam of optical energy may be referred to herein as a “light beam” or “optical beam.”

As used in the present specification and in the appended claims, the term “optical source” refers to a device from which optical energy originates. Examples of optical sources as thus defined include, but are not limited to, light emitting diodes, lasers, light bulbs, and lamps.

As used in the present specification and in the appended claims, the term “optical grating” refers to a body in which the refractive index varies periodically as a function of distance in the body.

As used in the present specification and in the appended claims, the term “evanescently coupled” refers to the physical proximity and orientation of at least two objects such that an appreciable amount of overlap occurs between evanescent optical-transmission fields in each of the objects.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative optical interconnects, illustrative systems, illustrative methods.

### Illustrative Optical Interconnects

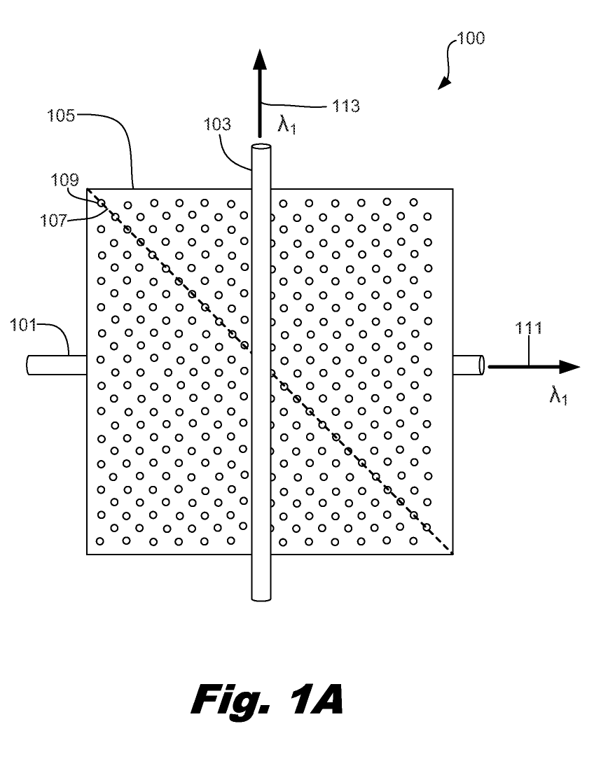

Referring now to FIGS. 1A-1B, an illustrative optical interconnect (100) is shown. FIG. 1A shows a front view of the illustrative optical interconnect (100), and FIG. 1B shows a side view of the illustrative optical interconnect (100).

The illustrative optical interconnect (100) may include a first optical waveguide (101) and a second optical waveguide (103) that are substantially perpendicular to each other. In certain embodiments, the first and second optical waveguides (101, 103) may be individual optical fibers.

An optical grating (105) may be disposed between the first and second optical waveguides (101, 103). The optical grating (105) may include any non-absorbing (i.e. does not absorb emitted radiation) dielectric material. Examples of suitable materials from which the optical grating (105) may be fabricated include, but are not limited to, silicon, silicon dioxide, silicon nitride, and the like.

The optical grating (105) may also be evanescently coupled to each of the waveguides (101, 103). Consequently, evanescent regions of optical mode transmission or propagation corresponding to each of the waveguides (101, 103) overlap with several periods of the optical grating (105) when optical energy is present in one or both of the waveguides (101, 103).

The optical grating (105) may include a plurality of perforated rows (107) oriented at an angle of approximately 45 degrees with respect to the first and second optical waveguides (101, 103). The perpendicular orientation of the first and second optical waveguides (101, 103) will allow the straight rows of perforations (107) to have the approximately 45 degree angle with respect to both optical waveguides (101, 103) in spite of the optical waveguides (101, 103) not being parallel to each other.

Each row (107) may include a plurality of perforations (109) arranged substantially linearly. The size, spacing, and periodicity of the perforations (109) and rows (107) may affect the optical properties of the grating (105). In the present example, the optical grating (105) may be configured to allow an optical beam (111) of a certain wavelength λ₁ from the first optical waveguide (101) to couple to the second optical waveguide (103), thus creating a secondary optical beam (113) of the same wavelength λ₁ that propagates through the second optical waveguide (103).

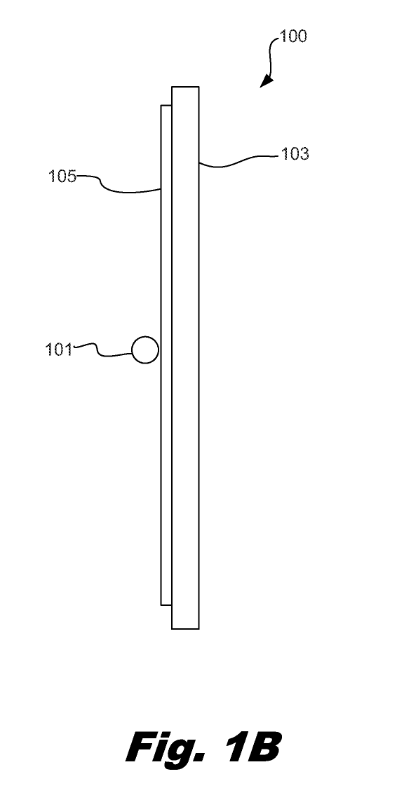

This may be accomplished by the optical grating (105) to providing a compensating angular momentum to optical energy in evanescent regions of the optical waveguides (101, 103), as will be explained in more detail with respect to FIG. 2. By changing the size, spacing, and/or periodicity of the rows (107) and perforations (109) in the optical grating (105), the wavelength of optical energy at which this compensatory effect is provided by the optical grating (105) may be selectively tuned.

The illustrative optical interconnect (100) may be used to selectively route optical signals along a desired path. For example, a data-bearing optical beam (111) propagating through the first optical waveguide (101) may be partially coupled into the second waveguide (103) such that the data is received by an optical component coupled to the second optical waveguide (103) in addition to, or instead of, an optical component coupled to the first optical waveguide (101). Thus, in various embodiments, the optical interconnect (100) may also be used to divide optical power between the waveguides (101, 103).

Referring now to FIG. 2, a vector diagram (200) is shown illustrating the compensatory effects of the optical grating (105, FIG. 1). These compensatory effects allow the coupling of optical energy between the first and second optical waveguides (101, 103, FIG. 1).

It is known that a periodic optical grating (105, FIG. 1) is capable of supplying “virtual photons” in an interaction between optical beams. These virtual photons are, in essence, an expression of the idea that an optical grating (105, FIG. 1) may supply angular momentum, but not energy, to an interaction between photons. For optical energy to be successfully coupled from the first optical waveguide (101, FIG. 1) to the second optical waveguide (103, FIG. 1), both energy and angular momentum must be conserved in the photons of the interaction.

The optical grating (105, FIG. 1) may be configured to provide a compensating amount of angular momentum that allows the conservation of angular momentum and, by extension, the optical energy being transferred. The periodicity of the grating (105, FIG. 1) may define the momentum which is available to the coupling interaction.

As shown in FIG. 2, the angular momentum of the photons in the optical beams (111, 113, FIG. 1) propagating through the first optical waveguide (101, FIG. 1) and received into the second optical waveguide (103, FIG. 1) may be modeled as vectors k₁ and k₂, respectively. The angular momentum imparted to the interaction by the optical grating (105, FIG. 1) may be modeled as vector k_{g}.

The magnitude of k₁ and k₂ for a particular mode may be equal to the product of 2π times the effective index of refraction n for that particular mode divided by the wavelength λ₁ of the optical energy, as follows:

kᵢ=2πnᵢ/λ₁

The vectors k₁ and k₂ point in the direction of propagation, and therefore point in the same direction as the first and second optical waveguides (101, 103, FIG. 1), respectively.

The grating momentum vector k_{g} may point in a direction corresponding to the orientation of the rows (107, FIG. 1) in the optical grating (105, FIG. 1). The magnitude of k_{g} may be equal to the quotient of 2π divided by the grating period Λ_{g}, according to the following equation:

k_{g}=2π/ [symbol] _{g}

As shown in FIG. 2, the grating period Λ_{g} may be selected to provide that k_{g} may be equal in magnitude and opposite in direction to the combined vectors k₁ and k₂, thus enabling the transfer of optical energy from the first optical waveguide (101, FIG. 1) to the second optical waveguide (103, FIG. 1) notwithstanding the differences in orientation between the optical waveguides (101, 103, FIG. 1). Moreover, the grating period can be chosen to avoid coherent backscattering of light propagating in each waveguide, by insuring k₁-k₂ is the smallest reciprocal lattice vector.

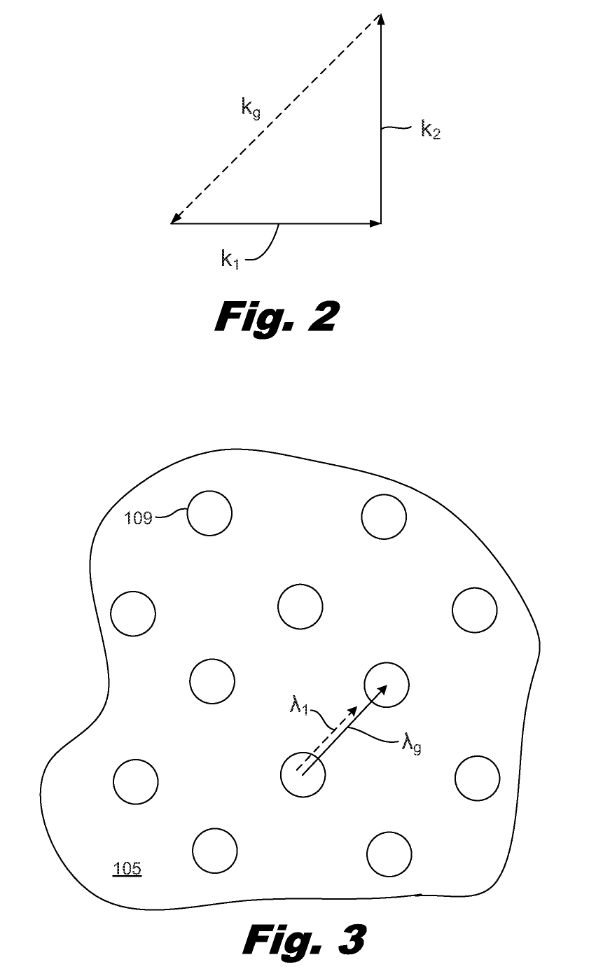

Referring now to FIG. 3, a closer view of the perforations (109) in the optical grating (105) is shown. The smallest distance between neighboring perforations (109) in an optical grating (105) generally correlates with the smallest wavelength of optical energy that the optical grating (105) is able to support in free space radiation. This distance λ_{g} is shown in comparison to the wavelength λ₁ of the optical energy propagating through the first and second optical waveguides (101, 103, FIG. 1). As shown in FIG. 3, the minimum free space wavelength λ_{g} supported by the optical grating (105) is substantially larger than the characteristic wavelength λ₁ of the optical energy propagating through the first and second optical waveguides (101, 103, FIG. 1).

Thus, the dimensions of the optical grating (105) and the wavelength λ₁ of the optical beams may be selected such that the optical grating (105) enables optical coupling between the first and second optical waveguides (101, 103, FIG. 1) while preventing losses due to free space radiation and back reflection of the optical energy through the body of the optical grating (105).

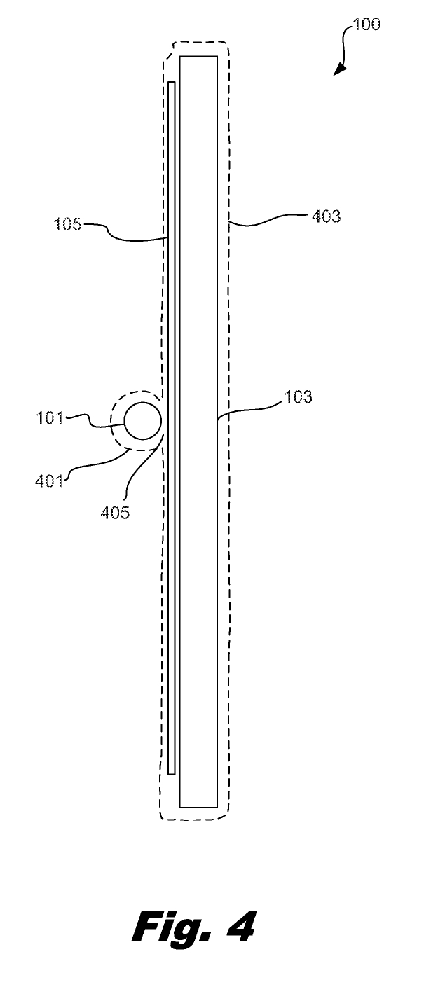

Referring now to FIG. 4, a side view of the illustrative optical interconnect (100) is shown together with approximate evanescent regions (401, 403) from the first and second optical waveguides (101, 103), respectively. The evanescent regions (401, 403) may be characterized as regions in which evanescent waves form from the optical beams (111, 113, FIG. 1) propagating through the optical waveguides (101, 103).

An optical beam can be induced within the second optical waveguide (103) from the optical beam (111) propagating through the first optical waveguide (101) when a region of overlap (405) between the evanescent regions (401, 403) occurs and the optical grating (105) provides the compensatory momentum k_{g} to allow for the conservation of angular momentum. In this way, optical energy may be coupled or transferred from the first optical waveguide (101) to the second optical waveguide (103).

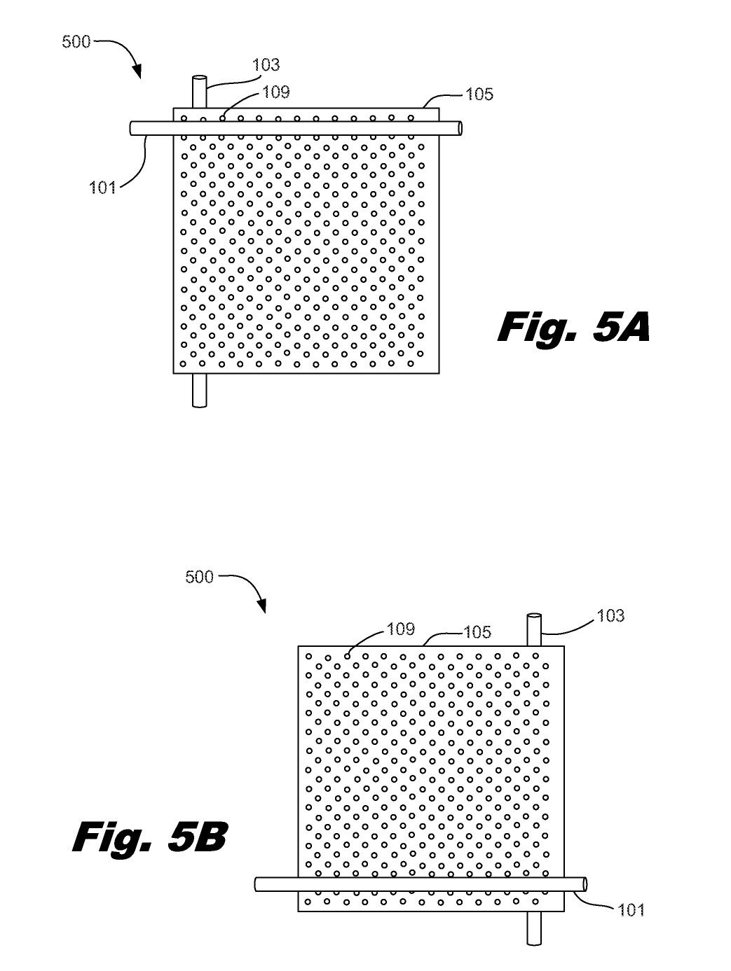

Referring now to FIGS. 5A-5B, an illustrative optical interconnect (500) is shown according to the principles described herein. In FIGS. 5A and 5B, the first and second optical waveguides (101, 103) are shown in different alignments with respect to the optical grating (105).

The optical interconnect (100) may effectively couple optical to energy between the waveguides (101, 103) in a variety of relative positions, provided that the following conditions are met: a) the optical waveguides (101, 103) are oriented substantially perpendicular to each other, b) rows of perforations (109) on the grating (105) are present at an angle of approximately 45 degrees with respect to the optical waveguides (101, 103), c) the optical grating (105) is disposed between the optical waveguides (101, 103), and d) the optical energy being coupled between the optical waveguides (101, 103) is of the characteristic frequency for which the optical grating (105) is configured to provide the compensatory angular momentum.

Thus, the optical interconnect (500) may be tolerant of a variety of alignments of the optical waveguides (101, 103) with respect to the optical grating (105).

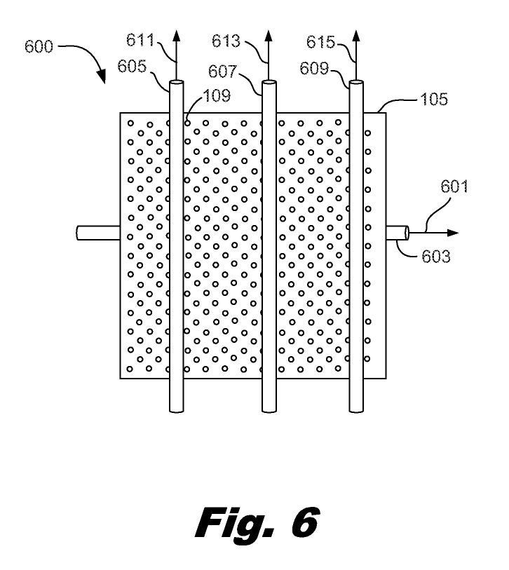

Referring now to FIG. 6, another illustrative optical interconnect (600) is shown that uses an optical grating (105) according to the principles described herein. In the present example, the optical interconnect (600) may be used as a beam splitter such that an optical beam (601) propagating through a source optical waveguide (603) may be coupled into a plurality of receiver optical waveguides (605, 607, 609), thereby inducing secondary optical beams (611, 613, 615) that correspond to the original optical beam (601) in each of the receiver waveguides (605, 607, 609).

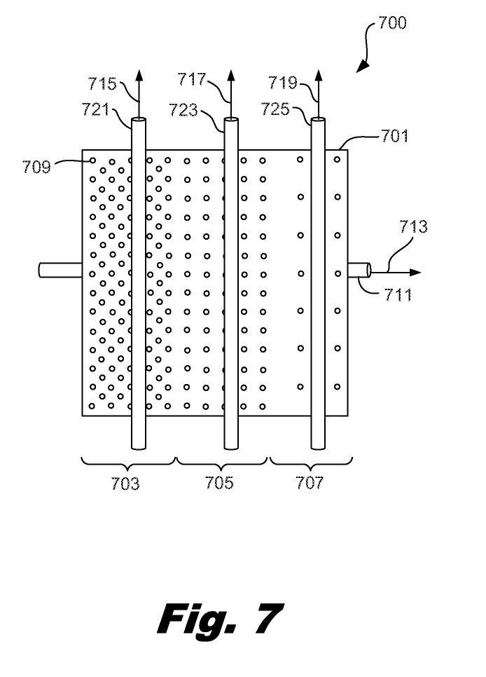

Referring now to FIG. 7, another illustrative optical interconnect (700) is shown. The optical interconnect (700) of the present example may include a grating (701) divided by periodicity into three distinct regions (703, 705, 707). Each of the distinct regions (703, 705, 707) may conform to the principles described in relation to the optical gratings described previously. However, the differences in periodicity of the perforations (709) may cause each of the regions to have a distinct k_{g} value and therefore enable optical coupling at distinct characteristic wavelengths.

The illustrative optical interconnect (700) may include a source optical waveguide (711) configured to propagate one or more optical beams (713) and induce secondary optical beams (715, 717, 719) within receiver optical waveguides (721, 723, 725) accordingly. Each of the receiver waveguides (721, 723, 725) may be associated with one of the regions (703, 705, 707) of the optical grating (701). Therefore, each of the receiver waveguides (721, 723, 725) may be configured to receive coupled optical energy from the source waveguide (711) at a different characteristic wavelength.

In certain embodiments, the source optical waveguide (711) may be configured to propagate a plurality of separate optical beams (713) at the characteristic wavelengths required by each of the regions (703, 705, 707) and couple optical energy from each of the optical beams (713) with its corresponding receiving waveguide (721, 723, 725).

In other embodiments, the optical interconnect (700) may be used as a type of wavelength division multiplexer. In such embodiments, optical power and/or data may be selectively routed from the source waveguide (711) to a receiver waveguide (721, 723, 725) by selectively altering the characteristic wavelength of an optical beam (713) propagating through the source optical waveguide.

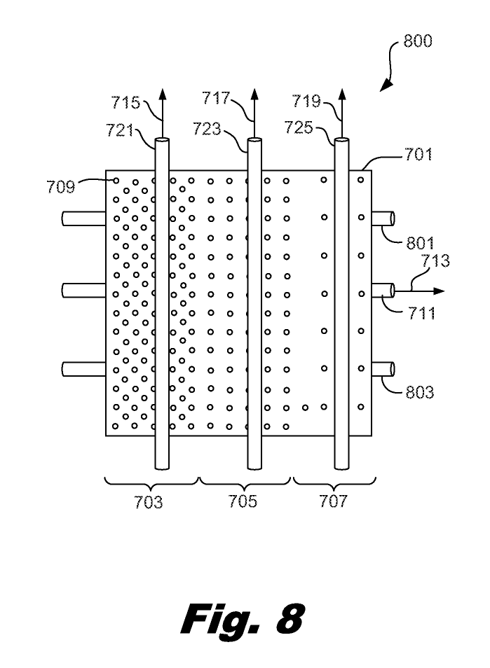

Referring now to FIG. 8, another illustrative optical interconnect (800) is shown. The optical interconnect (800) of the present example is very similar to the optical interconnect (700, FIG. 7) described above, with the addition of two source waveguides (801, 803). The present optical interconnect (800) may be used to selectively route optical energy from the source waveguides (711, 801, 803) to the receiver optical waveguides (721, 723, 725).

In certain embodiments, each of the source optical waveguides (711, 801, 803) may be configured to couple to only one of the receiver waveguides (721, 723, 725). Alternatively, each of the source optical waveguides (711, 801, 803) may be configured to propagate optical energy of a plurality of wavelengths.

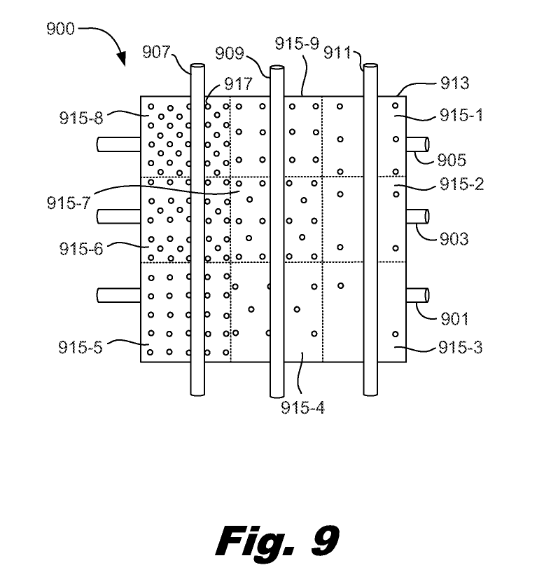

Referring now to FIG. 9, an illustrative optical interconnect (900) is shown according to the principles described herein with a plurality of source optical waveguides (901, 903, 905) and a plurality of receiver optical waveguides (907, 909, 911). The optical grating (913) disposed between and evanescently coupled to the source optical waveguides (901, 903, 905) and the receiver optical waveguides (907, 909, 911) may include a plurality of regions (915-1 to 915-9), with each of the regions (915-1 to 915-9) having a unique periodicity of perforations (917).

Each of the regions (915-1 to 915-9) may correspond to and be disposed between an intersection of a single source waveguides (901, 903, 905) and a single receiver waveguide (907, 909, 911). Thus, a unique wavelength of optical energy may be used to couple optical energy between a source waveguide (901, 903, 905) and a receiver waveguide (907, 909, 911) at each intersection. As such, an optical multiplexer utilizing unique addressing between each of the source waveguides (901, 903, 905) and each of the receiver waveguides (907, 909, 911) may be implemented using the present optical interconnect (900).

### Illustrative Optical Systems

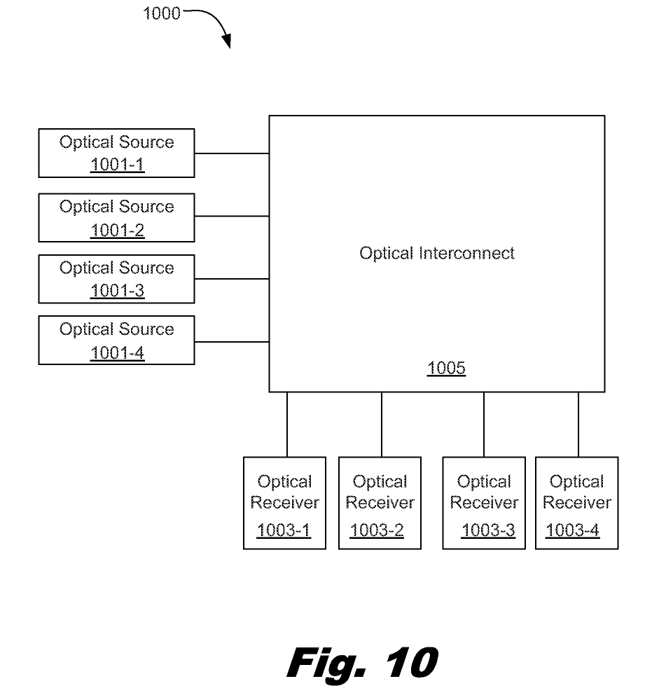

Referring now to FIG. 10, a block diagram of an illustrative optical system (1000) is shown. The illustrative system (1000) includes a number of optical sources (1001-1 to 1001-4) and a number of optical receivers (1003-1 to 1003-4) coupled to an optical interconnect (1005). The optical interconnect (1005) may be configured to selectively route and/or split optical beams produced by the optical sources (1001-1 to 1001-4) into the optical receivers (1003-1 to 1003-4).

Each of the optical sources (1001-1 to 1001-4) may be configured to produce an optical beam at a unique characteristic wavelength. The optical sources (1001-1 to 1001-4) may include, but are not limited to, light emitting diodes, diode lasers, vertical cavity surface emitting lasers (VCSELs), and any other light source that may suit a particular application. The optical sources (1001-1 to 1001-4) may be coupled to modulating elements (not shown) that selectively activate and deactivate the optical sources (1001-1 to 1001-4) to encode data onto the optical beams produced by the optical sources (1001-1 to 1001-4).

Each of the optical receivers (1003-1 to 1003-4) may be configured to detect optical energy and output an electrical signal corresponding to the intensity, duration, and/or wavelength of the optical energy received. In certain embodiments, the optical receivers (1003-1 to 1003-4) may include photodiodes and/or any other optical sensors that may suit a particular application. Demodulating circuitry may be used to extract digital data from variations in the electrical signals produced by the optical receivers (1003-1 to 1003-4).

The optical interconnect (1005) may be consistent with other optical interconnects described in the present specification in that the interconnect (1005) is configured to passively couple optical signals between source waveguides and receiver waveguides using an optical grating (913) consistent with the principles described in relation to FIGS. 1-9. Each of the optical sources (1001-1 to 1001-4) may be coupled to a corresponding source optical waveguide in the optical interconnect (1005), and each of the optical a receivers (1003-1 to 1003-4) may be coupled to a corresponding receiver optical waveguide in the optical interconnect (1005).

### Illustrative Methods

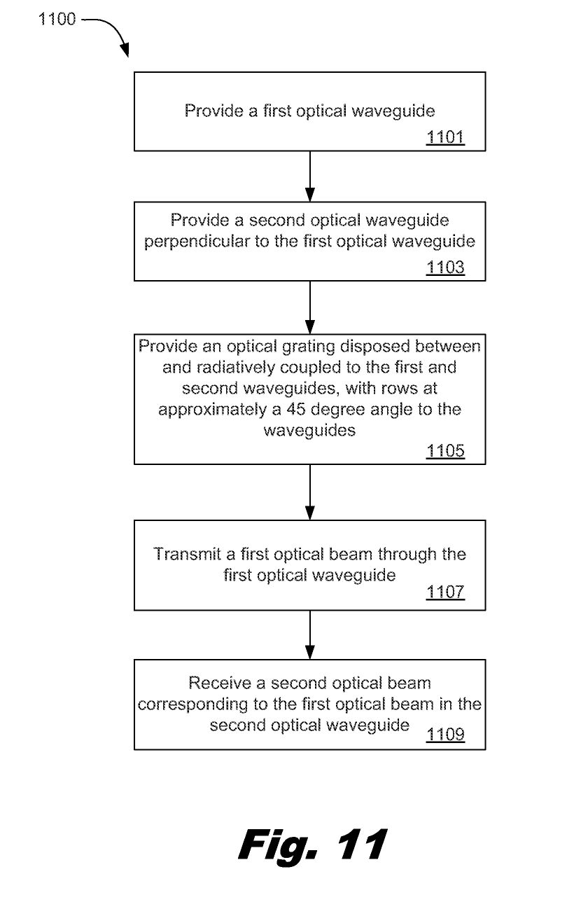

Referring now to FIG. 11, a block diagram of an illustrative method (1100) of optical transmission is shown. The method (1100) includes providing (step 1101) a first optical waveguide and providing (step 1103) a second optical waveguide perpendicular to the first optical waveguide. In certain embodiments, the optical waveguides may include one or more strands of optical fiber.

An optical grating is then provided (step 1105). The optical grating may be disposed between and evanescently coupled to the first and so second optical waveguides, with rows of perforations at approximately a 45 degree angle to the optical waveguides.

A first optical beam may then be transmitted (step 1107) through the first optical waveguide, and a corresponding second optical beam may be received (step 1109) in the second optical waveguide.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. An optical interconnect, comprising:
first and second substantially perpendicular optical waveguides; and
an optical grating disposed between and evanescently coupled to said first and second optical waveguides;
wherein said optical grating comprises a plurality of perforated rows oriented at an angle of approximately 45 degrees with respect to said first and second optical waveguides.

2. The optical interconnect of claim 1, wherein said optical grating comprises a periodicity configured to provide a compensating amount of angular momentum to couple optical energy of a certain wavelength between said first and second optical waveguides.

3. The optical interconnect of claim 1, wherein each of said first and second optical waveguides comprises at least one strand of optical fiber.

4. The optical interconnect of claim 1, wherein said grating comprises a non-absorbing dielectric material.

5. The optical interconnect of claim 1, further comprising an optical source coupled to said first optical waveguide.

6. An optical interconnect, comprising:
at least one source optical waveguide;
a plurality of substantially parallel receiver optical waveguides, said receiver waveguides being substantially perpendicular to said source waveguides; and
an optical grating disposed between and evanescently coupled to each of said source and receiver optical waveguides, said optical grating comprising a plurality of rows of perforations, said rows being oriented at an angle of approximately 45 degrees with respect to said source and receiver waveguides;
wherein said optical grating comprises a plurality of regions (915) of unique periodicity configured to couple optical energy between individual source and receiver waveguides.

7. The optical interconnect of claim 6, wherein said optical grating comprises a periodicity configured to provide a compensating amount of angular momentum to couple optical energy of a certain wavelength between said at least one source waveguide and at least one of said receiver waveguides.

8. The optical interconnect of claim 7, wherein said optical grating comprises a periodicity dimension that is smaller than said wavelength.

9. The optical interconnect of claim 6, wherein each of said optical waveguides comprises at least one strand of optical fiber.

10. The optical interconnect of claim 6, wherein said grating comprises a non-absorbing dielectric material.

11. The optical interconnect of claim 6, wherein said interconnect is configured to multiplex optical signals from said at least one source waveguide to said receiver waveguides.

12. A method, comprising:
providing first and second optical waveguides substantially perpendicular to each other;
providing an optical grating disposed between and evanescently coupled to said first and second waveguides, said optical grating comprising a plurality of rows of perforations oriented at an angle of approximately 45 degrees with respect to said first and second optical waveguides; and
transmitting an optical beam through said first optical waveguide.

13. The method of claim 12, wherein said optical beam is modulated with data.

14. The method of claim 12, further comprising receiving a secondary optical beam in said second waveguide corresponding to said optical beam transmitted through said first optical waveguide.

15. The method of claim 12, wherein said optical grating comprises a periodicity configured to provide a compensating amount of angular momentum to couple optical energy of a certain wavelength between said first and second optical waveguides.
